(19) United States
(12) Patent Application Publication
(10) Pub. No.: US 2006/0228671 A1
(43) Pub. Date: Oct. 12, 2006

(54) Combination dental mold and prosthesis

(76) Inventor: Frank Laspina, Cape Coral, FL (US)

Correspondence Address: CLIFFORD G. FRAYNE, 136 DRUM POINT RD, SUITE 7A, BRICK, NJ, 08723, US

(21) Appl. No.: 11/100,927

(22) Filed: Apr. 8, 2005

(51) Int. Cl. A61C 13/00; A61C 11/00

(52) U.S. Cl. 433/167; 433/213

(57) ABSTRACT

A premade flexible dental mold for forming a dental prosthesis or being incorporated in a dental prosthesis, the premade flexible mold having the prosthetic teeth mounted in a flexible gum-like substrate for incorporation the steps forming a dental prosthesis.

### BACKGROUND OF THE INVENTION

1. Field of the Invention

The present invention relates to dental prosthesis such as dentures, either full or partial, and temporary crowns and bridges and in particular, to a premade flexible mold utilized in operatory and laboratory full arch set ups or sectioned anterior and posterior working molds.

2. Description of the Prior Art

An individual requiring a dental prosthetic, either a partial denture, full denture, temporary crown or bridge, will be required to make several trips to the dentist office before the final prosthetic is finished. This is due to the cooperation between the dentist operatory, and the dental laboratory. The dentist must take a preliminary impression so that a model of the gums in the case of a full denture or a model of the teeth and gums in the case of a partial denture or bridge can be made. From the model, a custom tray is prepared so that a final impression may be taken. From the final impression there is fabricated the master cast from which a bite block is made so as to take a bite registration and horizontal and vertical profile. The laboratory then prepares a set up which is sent to the dentist for a try-in in the patient's oral cavity. Any last minute adjustments are made and the prosthesis is then returned to the laboratory for finishing and then returned to the dentist for insertion into the patient's oral cavity. These steps are detailed in FIG. 1 (prior art).

Applicant's invention of a premade flexible mold which can be reusable if so desired reduces the operatory time at the dentist's office and reduces patient's visits and laboratory procedures. It enables the dentist to take the bite and final impression and try in in one visit instead of several.

### OBJECTS OF THE INVENTION

An object of the present invention is to provide for a novel premade flexible mold used in dental operatory and laboratory set ups.

Another object of the present invention is to provide for a novel premade flexible dental mold utilized in dental operatory and laboratory set ups which reduces the number of visits required by the patient.

A still further object of the present invention is to provide for a novel premade flexible dental mold used in operatory and laboratory set ups in which the premade flexible dental mold may be incorporated in the final prosthesis.

### SUMMARY OF THE INVENTION

A premade flexible dental mold for forming a dental prosthesis or being incorporated in a dental prosthesis, the premade flexible mold having the prosthetic teeth mounted in a flexible gum-like substrate and incorporated in the steps of forming a dental prosthesis wherein the gum-like substrate can comprise a wax which allows the actual prosthetic teeth of the premade flexible mold to be incorporated into the subsequent dental prosthesis or the gum-like substrate can be comprised of a flexible vinyl or rubber in which case the premade flexible mold may be reused in subsequent dental prosthetic fabrications.

### BRIEF DESCRIPTION OF THE DRAWINGS

These and other objects of the present invention will become apparent, particularly when taken with the following illustrations wherein:

FIG. 1 is a flow diagram of the prior art;

FIG. 2 is a perspective view of the full arch flexible mold of the present invention;

FIG. 3 is a perspective view of the flexible mold of the present invention illustrating both anterior and posterior application;

FIG. 4 is a flow diagram of the fabrication of a dental prosthesis utilizing the flexible mold of the present invention.

### DETAILED DESCRIPTION OF THE DRAWINGS

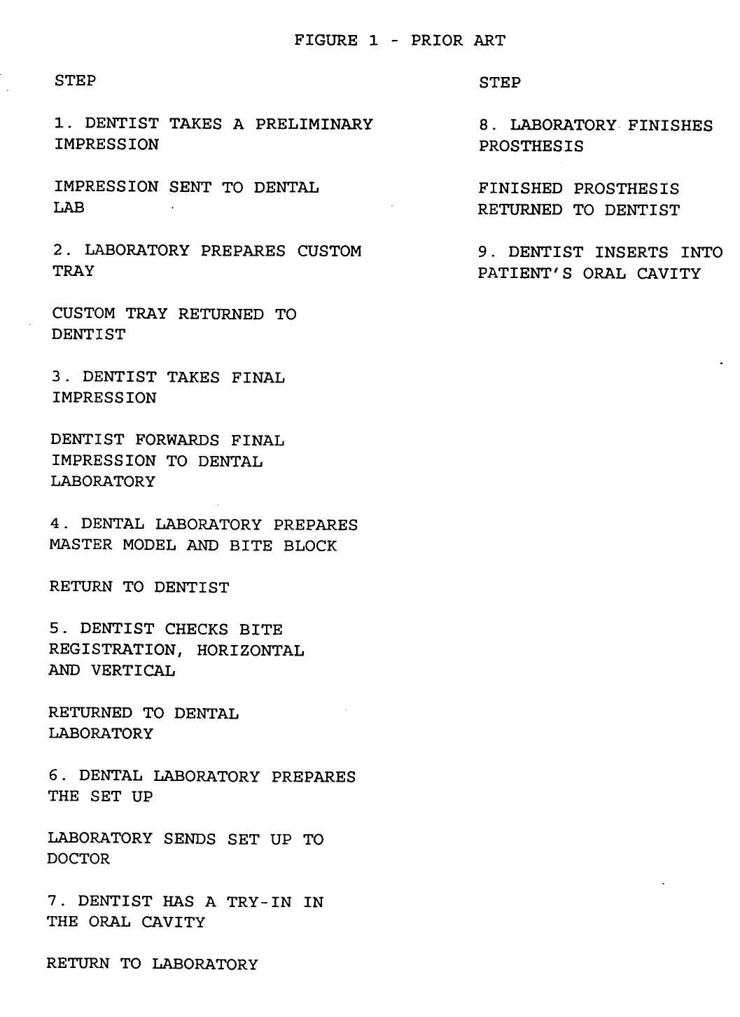

FIG. 1 is a flow chart of the steps necessary in the prior art to fabricate a dental prosthesis. The process takes essentially nine steps alternating between the dentist and the laboratory from the initial impression taken by the dentist to the preparation of the custom tray by the laboratory to the dentist taking a final impression and the laboratory preparing a bite block. Thereafter the dentist checks the bite registration and the laboratory prepares a set up which is returned to the dentist for a try-in. If the fit and registration is satisfactory, the laboratory finishes the prosthesis and it is returned to the dentist for use by the patient. Some of the visits to the dentist are very short, while others are lengthy, depending upon the step.

Applicant's invention eliminates certain visits to the dentist and the concomitant transport between the dentist and the laboratory. In particular, when using the preform mold device of Applicant's invention once the dentist has completed Step 3 (FIG. 1, prior art), Steps 4-8 can be completed by the dental laboratory so that the patient returns to the dentist for Step 9 (FIG. 1, prior art). As described hereafter, with Applicant's invention and method, steps two through six can be accomplished by the dental laboratory thereby freeing up the dentist to take on additional patients, and overall stream line the process of fabricating the dental prosthesis.

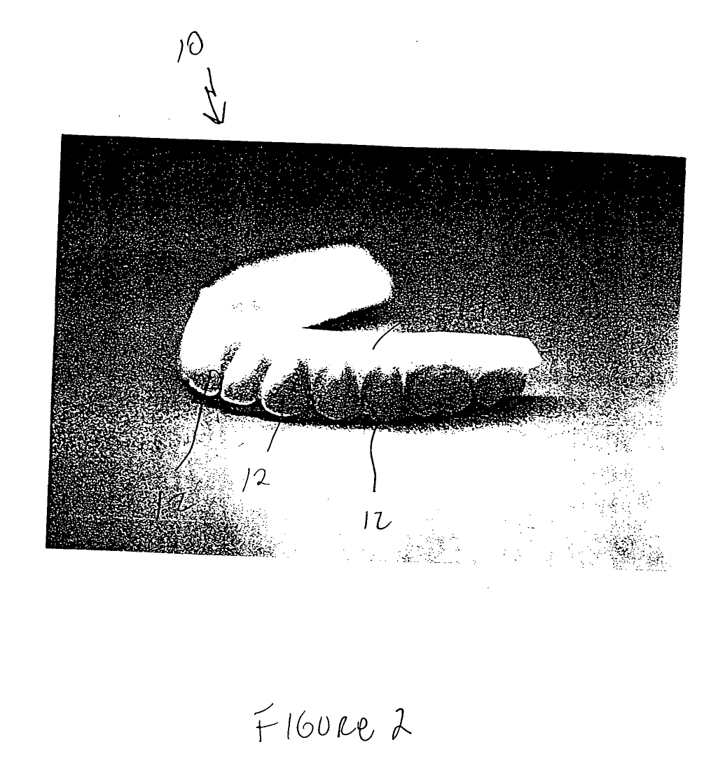

FIG. 2 is a perspective view illustrating the premade flexible dental mold 10 of the present invention representing a full arch, both anterior and posterior.

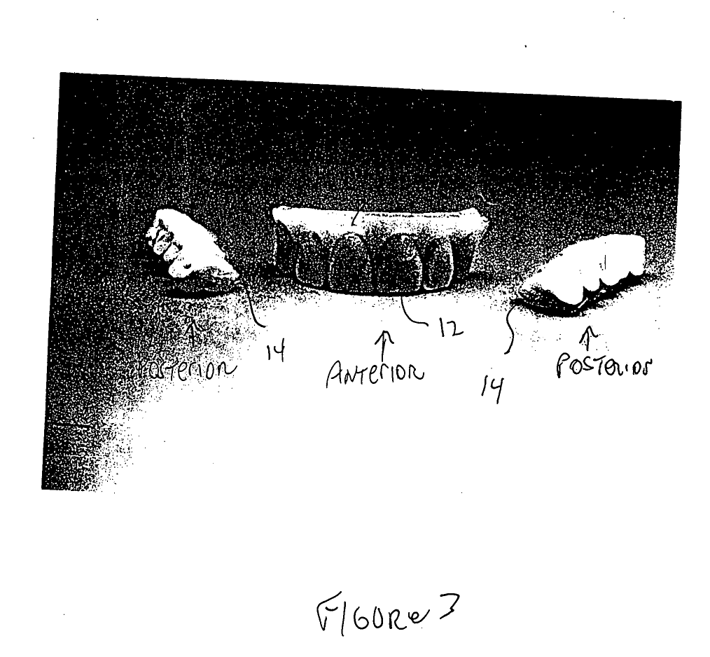

FIG. 3 is a perspective view of a segmented full arch illustrating the ability to fabricate partial dentures or temporary bridges or crowns.

The prosthetic teeth 12 are embedded within a flexible material 14. Flexible material 14 may comprise a waxy formable material for single use applications or a vinyl or rubbery material for multiple use applications in forming a dental prosthesis. The prosthetic teeth 12 embedded in the formable material 14 are identical to the prosthetic teeth which are utilized in forming the final dental prosthesis. For insertion into the oral cavity as such, a more aesthetic and better fit is assured. FIG. 2 illustrates the premade flexible dental mold of the present invention as it relates to a full arch prosthetic, however, it would have equal application to the posterior teeth either in a full or partial denture and to individual crowns and bridges (See FIG. 3). The formable material is flexible which allows the dentist to adjust it arcuately. The prosthetic teeth 12 are shaped and located to correspond to the human dentition. The use of the premade flexible dental mold 10 accelerates the denture fabrication process and eliminates certain visits by the patient by allowing certain steps to be accomplished in a single visit as set forth hereafter.

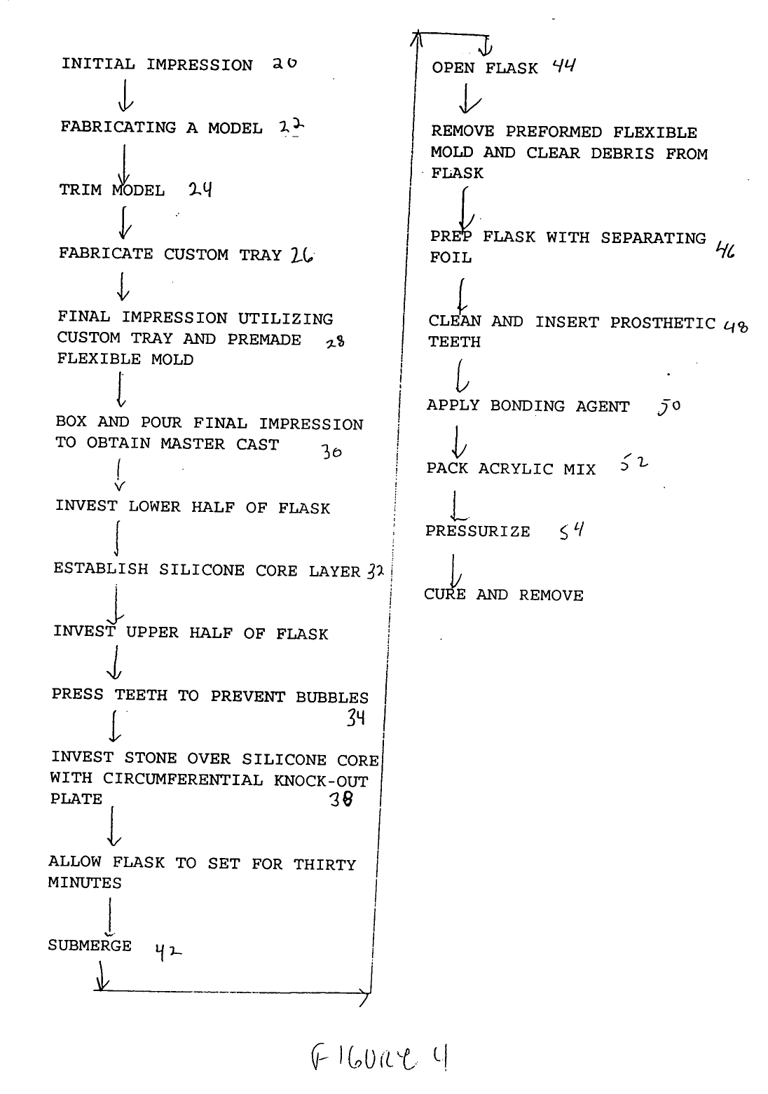

The procedure as set forth in schematic FIG. 4 initially proceeds along with steps similar to the fabrication of any dental prosthesis. An initial impression 20 is taken of the patient's mouth and a model is made of the gums 22. The model 22 is trimmed to eliminate the bulk and undercuts 24, blocked out, and thereafter a custom tray 26 is prepared.

In the patient's next visit, the custom tray 26 which is designed to conform to the gums and palate if necessary of the patient is positioned with the premade flexible mold 10. The dentist then lines up the mid line of the premade flexible mold and the posterior occlusion and takes a final impression 28.

The final impression 28 is then forwarded to the dental laboratory where the bite registration is again checked. The dental laboratory would then box and pour 30 the final impression in the normal fashion, then luted and articulated.

At this point, the lower half of the flask is invested, an insulating core layer 32 (silicone) is pressed about the teeth and the teeth are pressed and adapted into interproximal lingual areas to prevent bubbles 34, then, the upper half is invested. Stone is then invested over the silicone core 36. A circumferential knock-out plate 38 is incorporated to insure easy deflasking and to circumferentially support the silicone core to eliminate any distortion upon compression. The remainder of the flask is filled with stone 40 and allowed to set for approximately thirty minutes. It is then submerged and soaked for ten to twelve minutes at a water temperature of between 140 degrees Fahrenheit and 145 degrees Fahrenheit 42.

The wax having melted, the flask is opened 44. The preformed flexible mold 10 will be in the upper half and the impression in the lower half of the flask. The preformed flexible mold is secured in the silicone core.

The preformed flexible mold 10 is removed from the silicone core without causing damage to the silicone core. All traces or debris are then removed from the mold. At this stage the preformed flexible dental mold is out of the flask with only the wax and stone still remaining.

At this stage, the lower half of the flask is boiled out with water in a wax solvent, and when cooled, both halves of the flask are prepped with two coats of separating foil 46. The preformed flexible mold can be steamed to clean, sterilized and return to the dentist who can reuse it over and over again.

At this stage, the set of teeth are cleaned and inserted into the mold 48. The teeth utilized will be teeth from the same manufacturer and identical to the prosthetic teeth utilized in the preformed flexible mold. Once the teeth have been inserted into the mold, a bonding agent 50 is applied and the acrylic mix is preferably packed, but maybe poured 52. The flask with the prosthetic teeth bonding agent and acrylic is then pressurized in the normal course at approximately 3,500 PSI for fifteen to twenty minutes 54. The curing of the flask is then conducted in the normal fashion and then the prosthesis is removed from the flask. The finished prosthesis is then checked for occlusion and bite and is ready to be returned to the dentist for use by the patient.

The preformed flexible mold of the present invention may be also utilized in the fabrication of crowns and temporary bridges. In doing so, many of the steps as illustrated in FIG. 4 have application. An impression of the patient's mouth would be obtained and the laboratory would grind down the impressioned teeth anticipating the amount of removal that the dentist would do. The flexible premold would then be luted into position for that portion of the oral cavity undergoing the prosthetic work and there would be a wax up forming a matrix which would then be separated from the impression. The flex mold would then be removed from the matrix and cleaned. The prosthetic teeth would then be positioned in the matrix and a bonding agent applied, it would be packed or poured with acrylic mix and then cured, separated, trimmed and finished. This provides for an efficient way of fabricating a temporary bridge or crown and provides a more natural aesthetic appearance.

The preform mold of the present invention is also extremely useful to the dentist in providing the proper shade of the prosthetic teeth and the proper sizing of the prosthetic teeth. This is due to the fact that the preformed mold may come with prosthetic teeth positioned therein of uniform shade, but the shade differing from preform mold to preform mold. Similarly, the size of the prosthetic teeth in the preform mold may be varied from mold to mold in order that the dentist can accurately match the sizing to the natural teeth which have been lost or removed.

While the present invention has been described with respect to the exemplary embodiments thereof, it will be recognized by those of ordinary skill in the art that many modifications and changes can be made without departing from the spirit and scope of the invention. It is therefore manifestly intended that the invention be limited only be the scope of the claims and the equivalence thereof.

I claim:

1. A dental prosthesis preform device comprising:
a plurality of prosthetic teeth corresponding in shape and position to a portion of the human maxillary and mandibular dentition, said prosthetic teeth being mounted on a resilient, flexible strata emulating the gingiva, said dental prosthesis preform device utilized in obtaining a final impression of said portion of said human maxillary and mandibular dentition for fabrication of a dental prosthetic, said dental prosthetic having prosthetic teeth secured.

2. The dental prosthesis preform device in accordance with claim 1 wherein said resilient, flexible strata comprises rubber.

3. The dental prosthesis preform device in accordance with claim 1 wherein said resilient, flexible strata comprises vinyl.

4. The dental prosthesis preform device in accordance with claim 1 wherein said prosthetic teeth secured to said dental prosthetic are identical to said prosthetic teeth of said dental prosthesis preform device.

5. The dental prosthesis preform device in accordance with claim 1 wherein said resilient, flexible strata comprises wax and said prosthetic teeth of said dental prosthesis preform device are incorporated into said dental prosthetic.

6. A dental prosthesis preform device in accordance with claim 1 wherein the shading of the prosthetic teeth may be varied from preform device to preform device.

7. A dental prosthesis preform device in accordance with claim 1 wherein the size of said prosthetic teeth in said preform device may be varied from one said preform device to another said preform device.

8. A method for fabricating and fitting a prosthetic denture comprising:
a. providing a denture preform device comprising a set of prosthetic teeth corresponding in shape and position to the human maxillary and mandibular dentition, said prosthetic teeth being secured in a resilient flexible strata emulating gingiva;
b. placing said prosthetic preform device in the oral cavity of a person to be fitted for denture prosthetic and forming a final impression of said portion of said oral cavity;
c. boxing and pouring final impression to obtain master cast with denture preform device;
d. establish a silicone core layer and invest stone over silicone core layer;
e. prep flask with separating foil;
f. clean and insert prosthetic teeth;
g. apply bonding agent;
h. pack acrylic mix;
i. pressurize;
j. cure and remove.

9. A method for fabricating and fitting a temporary dental prosthetic bridge or crown comprising:
a. providing a denture preform device comprising a set of prosthetic teeth corresponding in shape and position to the human maxillary and mandibular dentition, said prosthetic teeth being secured in a resilient flexible strata emulating gingiva;
b. obtaining an impression of the desired maxillary and mandibular dentition;
c. grind the selected maxillary or mandibular dentition in anticipation of dentition removal by dentists;
d. position the preform device on the ground impression;
e. wax up the impression to form a matrix;
f. separate the matrix from the impression;
g. remove the flex mold and clean position;
h. position prosthetic teeth in the matrix;
i. apply bonding agent;
j. pack acrylic mix;
k. pressurize, cure, and separate;
l. trim and finish.
